(19) United States
(12) Patent Application Publication
(10) Pub. No.: US 2009/0012634 A1
(43) Pub. Date: Jan. 8, 2009

(54) ELECTRICALLY ADJUSTABLE FURNITURE PIECE AND METHOD FOR SERVICING AN ADJUSTABLE FURNITURE PIECE

(75) Inventor: Walter Koch, Schwanberg (AT)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: Logicdata Electronic & Software Entwicklungs GmbH, Deutschlandsberg (AT)

(21) Appl. No.: 12/172,492

(22) Filed: Jul. 14, 2008

Related U.S. Application Data
(63) Continuation of application No. PCT/EP2007/000476, filed on Jan. 19, 2007.

(30) Foreign Application Priority Data
Jan. 20, 2006 (DE) 102006002887.2

(51) Int. Cl. G06F 17/00; A47B 9/00

(52) U.S. Cl. 700/90; 108/20

(57) ABSTRACT

The invention concerns an electrically adjustable item of furniture having at least one electric drive motor, at least one control device for operating the drive motor, and a display unit, characterized in that the control device is able to encode operating status data into a status code, and the display device is capable of displaying the status code, so that this can be transmitted to an evaluation unit for servicing purposes. The invention moreover concerns methods for servicing an electrically adjustable item of furniture.

### REFERENCE TO RELATED APPLICATION

This application is a continuation of PCT/EP2007/000476, that claims priority to the benefit of the priority date of German Patent Application No. DE200610002887.2, filed on Jan. 20, 2006, the contents of which are herein incorporated by reference in their entirety.

### FIELD OF THE INVENTION

Electrically adjustable item of furniture and a method for servicing an electrically adjustable item of furniture

### BACKGROUND OF THE INVENTION

A working table having a working top whose height can be adjusted is known from DE 299 18 086 U1. The working table incorporates a drive motor, a control device and an input unit with a display. The control device is here operated via the input unit, whose display indicates the current adjustment of the working top.

The control device used here can be adapted to a wide range of possible applications, which means that it must be configured appropriately for a particular possible application. Errors can occur here or in later use that make it necessary to service either the table or the control device.

At present, servicing can only be carried out by a servicing technician who examines the control device at the place where it is being used and who, if necessary, adapts it again to the requirements of the application. Servicing of this type is relatively expensive. It can also happen that a servicing technician must come a number of times to the place of use, as it is not possible to identify accurately the type of fault, and thereby the need for spare parts, in advance.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One embodiment of the disclosure is an electrically adjustable item of furniture of the type mentioned at the beginning, but that is particularly easy to service.

Another embodiment is a particularly economical and flexible method of servicing for an item of furniture of this type.

In yet another embodiment is an electrically adjustable item of furniture with at least one electric drive motor, at least one control device for operating the drive motor, and a display unit. The control device is set up to encode data relating to the operating condition in a status code, and the display unit is enabled to display the status code, allowing this to be transmitted to an evaluation unit for servicing purposes.

One embodiment is an electrically adjustable item of furniture with at least one electric drive motor and at least one control device for operating the drive motor, in that the control device incorporates a data interface for connection to data transfer equipment. The data interface is set up for communication with an evaluation unit for servicing purposes.

One embodiment comprises a method for servicing an electrically adjustable item of furniture comprising acquiring operating status data, encoding the operating status data in a status code, and transmitting the status code over a communication network, particularly a public communication network, to an evaluation unit. The method further comprises decoding the operating status data encoded in the status code by the evaluation unit and evaluating the decoded operating status data for servicing purposes.

Another embodiment is a method for servicing an electrically adjustable item of furniture comprising preparing control data, transmitting the control data over a communication network, in particular a public communication network, to a control unit, and evaluating the transmitted control data by the control device.

According to one embodiment of the invention, an electrically adjustable item of furniture is fitted with a data interface for transmitting an operating status data from the control device to an evaluation unit. In this way, an operating status of the control device can be evaluated by an evaluation unit, allowing possible fault causes to be determined without the necessity of a visit by servicing personnel.

According to a further embodiment of the invention, the evaluation unit is made capable of transmitting control information through the data transfer equipment to the data interface, and the control device is set up to evaluate control information that is transmitted. By transmitting control information from the evaluation unit to the control device, settings can even be made remotely, as a result of which on-site servicing can often be omitted.

According to a further embodiment, the control device incorporates a program memory and a data memory, while the control data contains data for updating the control program or a configuration stored in the data memory.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### BRIEF DESCRIPTION OF THE DRAWINGS

Aspects of the invention are made more evident by way of example in the following detailed description of embodiments when read in conjunction with the attached drawing figures.

FIG. 1 a schematic illustration of an electrically adjustable working table,

FIG. 2 a schematic illustration of an electrically adjustable hospital bed,

FIG. 3 a flow diagram of a first method for servicing an electrically adjustable item of furniture according to one embodiment of the invention,

FIG. 4 a flow diagram of a second method for servicing an electrically adjustable item of furniture according to one embodiment of the invention.

### DETAILED DESCRIPTION OF THE INVENTION

In the following one or more aspects and/or embodiments of the invention are described with reference to the drawings, wherein like reference numerals are generally utilized to refer to like elements throughout. In the following description, for purposes of explanation, numerous specific details are set forth in order to provide a thorough understanding of one or more aspects of embodiments of the invention. It may be evident, however, to one skilled in the art that one or more aspects of the embodiments of the invention may be practiced with a lesser degree of these specific details.

In other instances, known structures and devices are shown in block diagram form in order to facilitate describing one or more aspects of the embodiments of the invention. The following description is not to be taken in a limiting sense, and the scope of the invention is defined by the appended claims.

In addition, while a particular feature or aspect of an embodiment may be disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. The terms “coupled” and “connected”, along with derivatives may be used. It should be understood that these terms may be used to indicate that two elements co-operate or interact with each other regardless of whether they are in direct physical or electrical contact, or are not in direct contact with each other. Also, the term “exemplary” is merely meant as an example, rather than the best or optimal.

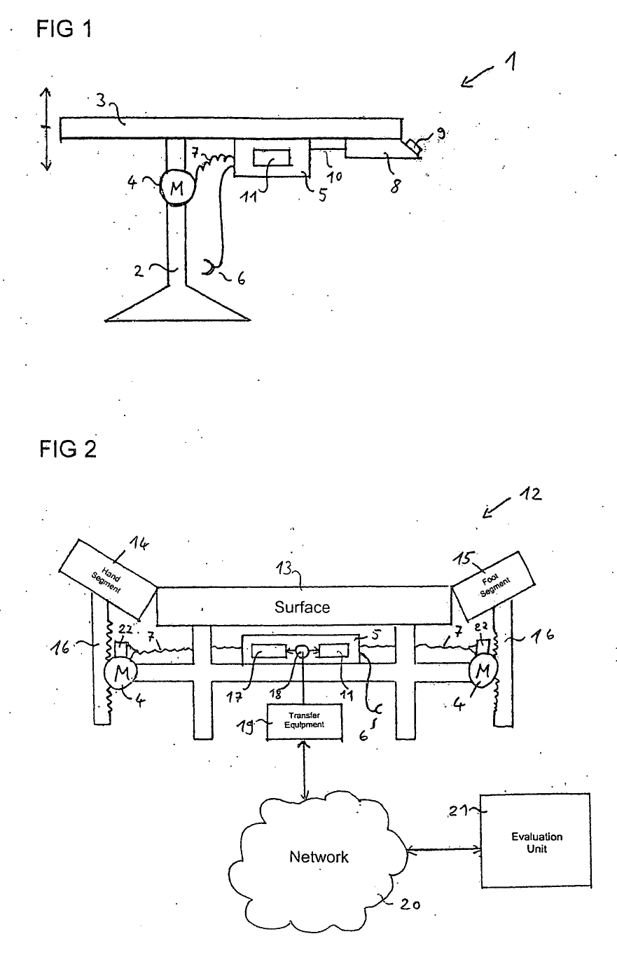

FIG. 1 shows a schematic illustration of a working table 1 with electrically adjustable height. The working table 1 incorporates a leg 2, as well as a working top 3. The height of the working top 3 can be adjusted by a drive motor 4 that adjusts the length of the leg 2 through corresponding drive equipment. The drive motor 4 is controlled by a control device 5 which, in this embodiment, is mounted under the working top 3. The control device 5 is connected for this purpose through a mains cable 6 to a power supply network, and through a flexible cable 7 to the drive motor 4.

The control device 5 is controlled through an input unit 8 that incorporates a display unit 9. The input unit 8 is connected for this purpose through a further cable 10 to the control device 5. It is, alternatively, also possible for the input unit 8 or the display unit 9 to be integrated into the control device 5.

The input unit 8 in the illustrated embodiment has buttons for manually raising and lowering the working top 3. It is also possible for buttons or switches for the adoption of pre-specified positions of the working top to be integrated into the input unit 8. A 7-segment light-emitting diode display, or a liquid crystal display, are, for instance, suitable as display units 9.

As alternatives to the input unit 8 illustrated in FIG. 1, infra-red remote-control units, cable or radio remote-control units, or a control program running on a computer, can be used to operate the control device 5 and thereby the electric motor 4.

The control device 5 incorporates a data memory 11 in which a current configuration of the control device 5 is stored. Such a configuration can, for instance, contain data relating to the maximum range of movement of the working table 1, the minimum and maximum speeds of the electric motor 4, or data relating to its voltage and power supply.

A control program, also held in the control device 5, watches for the occurrence of errors in the control device 5. The working table 1 can, for instance, incorporate additional sensors for detecting stop positions or crushing forces that are not, however, illustrated on FIG. 1. If, for instance, measured sensor values do not match the expected values, or if the configuration held in the data memory 11 is not internally consistent, for example because a minimum height set for the working top 3 is larger than a maximum height set for the working top 3, the control program in the control device 5 recognizes an error.

In case of error, all the relevant data in the data memory 11 is encoded into a compact status code which can then be displayed to the user through the display unit 9. An error code for an unacceptable setting of the working top height can, for instance, be encoded together with the parameters for the minimum and maximum heights of the working top in a hexadecimal code which is then output on the display unit 9.

In order to make a distinction from the information normally shown on the display unit 9, such as the currently selected height for the working top 3, the display can, for example, be made to flash. It is alternatively possible to employ an additional indication of an error status, such as the illumination of an additional light emitting diode, or the generation of an audible warning.

A user who has in this simple way been informed of the error in the control device 5 now only needs to convey the displayed status code to a servicing centre, perhaps that of the manufacturer of the working table 1. It is, for instance, possible to convey the status code to an employee at the service centre by telephone. The employee at the service centre can then enter this status code into a suitable evaluation unit that decodes the operating status data contained in the code and in this way is easily able to determine the fault.

It is alternatively possible to transmit or to evaluate the data automatically, for instance by using what is known as a web service, that takes the data shown on the display unit 9 as input parameters. In the sense of this description, a web service refers to any evaluation unit that can be reached over a communication network and that is able to accept the operating status data. It is unimportant here whether the web service operates fully automatically, such as through data transfer according to the Simple Object Access Protocol (SOAP), which is suitable for platform-independent machine communication, or whether a corresponding status code is entered manually by a user, for instance through entering the status code into an appropriate form on a web page or into a telephone computer, for example by means of voice recognition.

In those cases where the fault is relatively easy to determine and to rectify, the employee at the service centre, or an automatic evaluation unit, can offer helpful advice to the user on rectifying the fault. The user can, for instance, be instructed in how to properly set the minimum and maximum heights of the working top 3.

If, on the other hand, the transmitted operating status data indicates the presence of a fault of that is not so easy to rectify, such as a faulty sensor or drive motor 4, a servicing technician can be sent to service the working table 1, already in possession of suitable spare parts. The servicing technician does not therefore have to make two visits, one to determine the fault and a second to rectify the fault.

FIG. 2 schematically illustrates an electrically adjustable hospital bed 12. The bed includes a horizontal lying surface 13, and adjustable head segment 14, and an adjustable foot segment 15.

The inclinations of the head segment 14 or of the foot segment 15 can each be adjusted by a lifting rod 16 with the aid of a drive motor 4. Sensors 22, furthermore, are positioned in the region of the lifting rods, detecting, for instance, a position or speed of the lifting rod 16. Both the drive motors 4 and sensors 22 are connected to a common control device 5 by a cable 7.

The control device 5 incorporates a data memory 11 and a program memory 17, and is supplied with power over a mains cable 6. The control device 5, moreover, incorporates a data interface 18, by means of which the control device 5 is connected to data transfer equipment 19. The data transfer equipment 19 can, for instance, consist of a computer connected for operation of the hospital bed 12, or another device such as a modem or a network router provided for data transmission.

It is also possible to carry out data transfer by using a mobile device as data transmission equipment 19, for instance using “Smartphones” or Personal Digital Assistants (PDAs). This can be particularly advantageous if the control device 5 incorporates a wireless interface 18 such as an infrared interface using the IrDA standard for connection to an input unit. By means of such an interface 18, a mobile device having an interface of the same type can access data in the memories 11 and 17 of the control device 5, and can make these available through another interface, for instance to a GSM data network 20, for servicing purposes.

In the embodiment illustrated in FIG. 2, the data transfer equipment 19 is connected to a data network 20, such as to the Internet. An evaluation unit 21, consisting of a computer in the illustrated embodiment, is also connected to the data network 20. The evaluation unit 21 can be close to the hospital bed 12 or can be located remotely. It can, for instance, be located in a service centre of a manufacturer of the hospital bed 12, or in an engineering centre in the hospital where the hospital bed 12 is sited.

It is, furthermore, possible to use a mobile device such as a Smartphone or a PDA as an evaluation unit 21. In this way the evaluation unit 21 is also available to a servicing technician on-site for subsequent fault analysis and for control of the item of furniture 12.

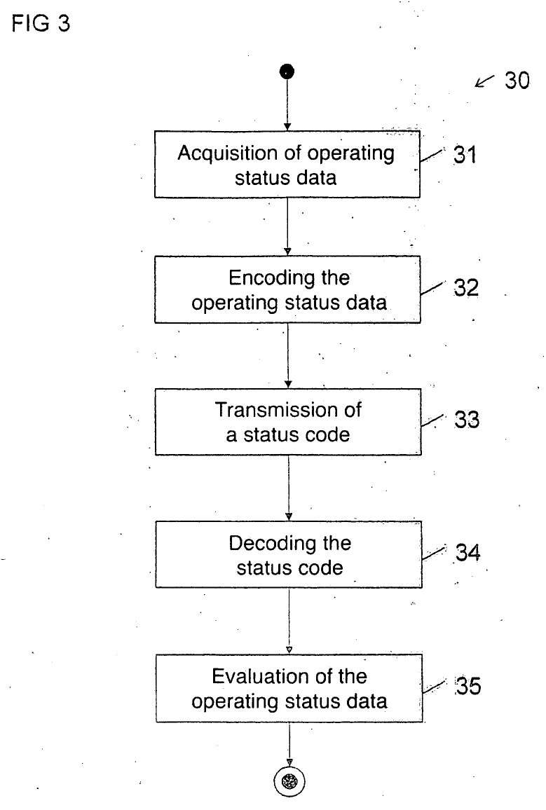

FIG. 3 illustrates a flow diagram for a first method 30 for servicing an electrically adjustable item of furniture.

In a first step 31, operating status data for an electrically adjustable item of furniture 1 or 12 is acquired. A control device 5 can, for instance, acquire configuration data stored in a data store 11, data from a sensor 22, or a version number for a running control program located in the program memory 17. The operating status data can, additionally, include motor speeds, currents, voltages or torques, distances covered, or pre-specified positions.

It is possible, for instance, for operating status to be acquired continuously, or at regular intervals, or for it to be triggered by the occurrence of an error or by a user action. It is also possible to start the acquisition, and the following steps, in response to a request from a service centre.

In a further step 32, the operating status data that has been acquired is encoded in a status code. The control device 5 can, for instance, summarize the operating status data that has been acquired in the form of a particularly compact code for display by a display unit 9, or in a data format that is suitable for the transmission of data to a remote destination, such as, for instance, a query to a web service on a remote computer in accordance with the Simple Object Access Protocol (SOAP).

In a further step 33, the status code is transmitted via a public communication network 22 and evaluation unit 21.

For instance, a status code shown on a display unit 9 can be communicated by a user of the working table 1 over the telephone to a worker at a service centre with an evaluation unit 21. It is, alternatively, also possible to transmit a status code electronically via a data interface 18, data transfer equipment 19 and a data network 20 directly to an evaluation unit 21.

In a next step 34, a transmitted status code is decoded by the evaluation unit 21, so that the operating status data encoded within it is available to the evaluation unit 21. For instance, a web service can extract the data encoded in a query to the web service, such as perhaps a configuration stored in a data memory 11, or an error message that has been transmitted, from the query it has received. Alternatively, an evaluation unit 21 can also decode the operating status data contained in a compact status code, so that this is then available in plain text.

In a following step 35, the decoded operating status data is evaluated for servicing purposes. A service technician can, for instance, obtain a display of the decoded operating status data from the evaluation unit 21 in plain text, and can draw conclusions as to the possible causes of faults or incorrect operation of the electrically operated furniture item 1 or 12 on the basis of the displayed operating status data.

As an alternative, or in addition, the evaluation unit 21 can perform an automatic plausibility check of the transmitted operating status data. It is possible, for instance, to check automatically whether the acquired a minimum data is smaller than the maximum data associated with it. The evaluation unit 21 can, furthermore, for instance, contain a database incorporating expert knowledge on permissible and impermissible operating statuses.

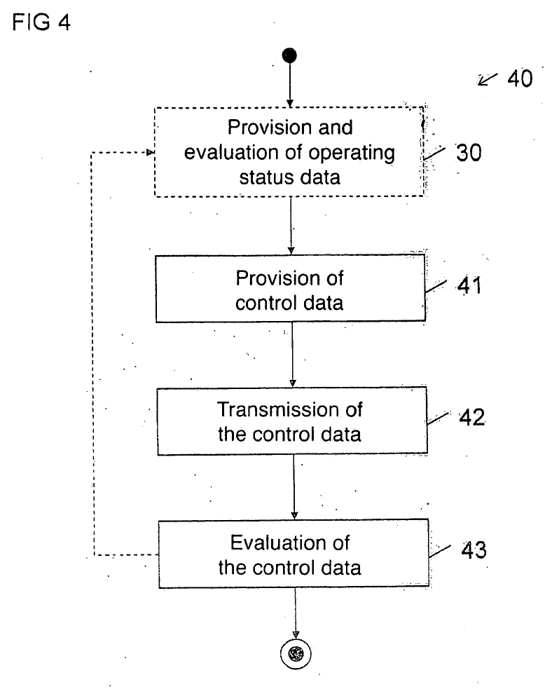

FIG. 4 illustrates a flow diagram for a second method 40 for servicing an electrically adjustable item of furniture 12. The second method 40 can be applied after the first method 30, or independently of it.

In a first step 41, control information is made available by an evaluation unit 21. For example, a service centre can make a new version of a control program available for controlling the item of furniture 12. As an alternative it is also possible that, following evaluation of operating status data, for example by means of the first method 30, modified configuration data is provided for an item of furniture 12. The changed configuration data can, for instance, contain new motor speeds or maximum permitted sensor values for configuration of the control device 5.

In a next step 42, the control data that has been prepared is transferred to a control device 5 of an electrically adjustable item of furniture 12. The control data can, for instance, be transmitted to the control device 5 with the aid of a data network 20 via data transmission equipment 19 and a data interface 18. The transfer can, for instance, involve a response to a query made to a web service running on the evaluation unit 21.

In a further step 43, the transmitted control data is evaluated by the control device 5 for further processing. For instance, a newly transferred version of a control program may be stored in a program memory 16. Alternatively, or in addition, it is also possible to place configuration data that has been transmitted into a data memory 11.

The methods 30 and 40 described above for servicing an electrically adjustable item of furniture 12 can also be carried out repeatedly, one after another, as is indicated by the dotted arrow returning from step 43 back to optional step 30 in method 40. In this way it is possible to implement interactive remote servicing of the electrically adjustable item of furniture 12 by the evaluation unit 21. A service technician working at the evaluation unit 21 can, for instance, test the drive motors 4 by sending suitable control data to the control device 5, and can monitor sensor data from the sensors 22 returned from the control device 5 to the evaluation unit 21.

For instance, a current profile for operating the drive motor 4 can be prepared for the control device 5 by monitoring the positioning speed using sensor 22 in such a way that it is operated with a specified, safe speed.

Servicing, in the sense of this description, refers to any procedure appropriate for setting up, recreating, improving, or extending a function of an electrically adjustable item of furniture. It is of no significance to this principle, whether parts of the item of furniture 1 or 12, or of the control device 5 are exchanged, removed or extended during servicing, as is the case in, for instance, the replacement of a faulty sensor 22 or of a drive motor 4, since an exchange, modification or removal of a control program or of configuration data required by a control program, can also be an appropriate way to restore, extend or improve a functionality of an electrically adjustable item of furniture.

Although specific embodiments have been illustrated and described, it will be appreciated by one of ordinary skill in the art that any arrangement which is calculated to achieve the same purpose may be substituted for the specific embodiment shown. It is to be understood that the above description is intended to be illustrative and not restrictive. The application is intended to cover any variations of the invention. The scope of the invention includes any other embodiments and applications in which the above structures and methods may be used. The scope of the invention should therefore be determined with reference to the appended claims along with the scope of equivalence to which such claims are entitled.

It is emphasized that the abstract is provided to comply with 37 CFR. Section 1.72(b) requiring an abstract that will allow the reader to quickly ascertain the nature and gist of a technical disclosure. It is submitted with the understanding that it will not be used to interpret or limit the scope of meaning of the claims.

What is claimed is:

1. An electrically adjustable item of furniture comprising:
at least one electric drive motor; and
at least one control device configured to operate the at least one electric drive motor,
wherein the at least one control device includes a data interface for connection to data transmission equipment, and
wherein the data interface is configured to communicate with an evaluation unit for servicing purposes.

2. The electrically adjustable item of furniture of claim 1, further comprising a display unit, wherein the at least one control device is configured to encode operating status data into a status code, and wherein the display unit is configured to display the status code, for transfer to an evaluation unit for servicing purposes.

3. The electrically adjustable item of furniture of claim 1, wherein the data interface for transmitting operating status data from the at least one control device to the evaluation unit is configured to output an operating status of the at least one control device for evaluation by the evaluation unit.

4. The electrically adjustable item of furniture of claim 1, wherein the evaluation unit is configured to transmit control information via the data interface to the at least one control device, wherein the at least one control device is configured to evaluate transmitted control information, and wherein the at least one control device is controlled in response thereto.

5. The electrically adjustable item of furniture of claim 3, wherein the at least one control device comprises a program memory with a control program for controlling the item of furniture, wherein control information comprises data for updating the control program, and wherein the control program is configured to be updated by the evaluation unit.

6. The electrically adjustable item of furniture of claim 1, wherein the at least one control device comprises a data memory with a configuration of the item of furniture, wherein operating status data or control data comprises configuration data, and wherein the configuration is evaluated or updated by the evaluation unit.

7. The electrically adjustable item of furniture of claim 1, wherein the data transmission equipment is a node in a data network.

8. The electrically adjustable item of furniture of claim 1, wherein the item of furniture comprises a table, a bed or a couch.

9. A method for servicing an electrically adjustable item of furniture comprising:
acquiring operating status data,
encoding operating status data into a status code,
transmitting the status code over a communication network to an evaluation unit,
decoding the operating status data encoded in the status code by the evaluation unit, and
evaluating decoded operating status data for servicing.

10. The method of claim 9, wherein the status code is displayed by a display unit, wherein the status code displayed is communicated by telephone to an operator or through a voice recognition system, and wherein the operator or the voice recognition system provides the status code transmitted to the evaluation unit.

11. The method of claim 9, wherein the status code is transmitted to the evaluation unit over a data network.

12. A method for servicing an electrically adjustable item of furniture comprising:
providing control data,
transmitting the control data via a communication network to a control device, and
evaluating transmitted control data by the control device.
